(19) United States
(12) Patent Application Publication
(10) Pub. No.: US 2026/0166849 A1
(43) Pub. Date: Jun. 18, 2026

(54) THERMOPLASTIC RESIN THIN FILM LAMINATE AND PROCESS FOR FABRICATION

(71) Applicants: FSPG HI-TECH CO., LTD., Foshan (CN); PGI Nonwovens (China) Co., Ltd., Suzhou (CN)

(72) Inventors: Yuwei Lin, Foshan (CN); Chaohui Cai, Foshan (CN); Jin Yongji, Suzhou (CN); Sven Krister Mikael Erlandsson, Suzhou (CN)

(21) Appl. No.: 19/536,797

(22) Filed: Feb. 11, 2026

Related U.S. Application Data
(62) Division of application No. 13/735,540, filed on Jan. 7, 2013, now abandoned.

(30) Foreign Application Priority Data
Jan. 9, 2012 (CN) 201210005351.2

(51) Int. Cl. B32B 7/14; B32B 5/00; B32B 5/02; B32B 27/08; B32B 27/12; B32B 27/32; B32B 27/36; B32B 27/40; B32B 37/12; B32B 38/00

(52) U.S. Cl. CPC B32B 7/14; B32B 5/00; B32B 5/022; B32B 5/026; B32B 27/08; B32B 27/12; B32B 27/32; B32B 27/36; B32B 27/40; B32B 38/0036; B32B 37/12; B32B 2250/02; B32B 2250/03; B32B 2250/40; B32B 2262/0253; B32B 2262/0261; B32B 2262/0276; B32B 2262/06; B32B 2305/18; B32B 2307/408; B32B 2307/412; B32B 2307/536; B32B 2307/538; B32B 2307/718; B32B 2307/724; B32B 2309/02; B32B 2309/105; B32B 2398/20; Y10T 428/24851; Y10T 428/24942; Y10T 428/26

(57) ABSTRACT

The present invention relates to a thermoplastic resin film laminate prepared by thermal compressing comprising: at least a thermoplastic resin film layer with a thickness of 1-250 μm, at least a thermoplastic resin product layer, and a bonding layer of glue in between the thermoplastic resin film layer and the thermoplastic resin product layer, wherein the thermoplastic resin product layer is a thermoplastic resin film or a thermoplastic resin fabric, and said thermoplastic resin fabric can be a woven fabric and/or a nonwoven. In the laminate of the present invention, the fabric has a gram weight of 1-250 g/m² and the bonding layer has gram weight of more than 0.1 g/m². The laminate of this invention has good breathability and high moisture transmission rate. The laminate is smooth with no wrinkles and has a soft handfeel.

### TECHNICAL FIELD

The present invention relates to a thermoplastic resin film laminate and method for preparing the same. To be more specific, the present invention relates to a laminate of a thermoplastic resin film, a thermoplastic resin product and an adhesive, and a method for bonding the same.

### BACKGROUND ART

Bonding products of thermoplastic resin film and thermoplastic resin product generally have the problems like a crimple appearance, curling inside the film, stiff handfeel, insufficient glue fastness, glue failure, etc. These problems bring huge pressure on technologies, markets, costs and etc., mainly because thermoplastic resin films have different elasticity as compared with fabric products, e.g., the differentiations between elastic film and unelastic fabric, stiff film and elastic fabric, ultra-thin film and ultra-thin fabric, film and ultra-thin fabric, elastic film and unelastic film. In the meantime, different glues have different behaviours after bonding, which is another cause of the above-stated problems.

CN 1111476C discloses a method for preparing a stretched breathable polyolefin film and fiber polyolefin nonwoven. As these two can hardly be thermally bonded, bonding is completed by adding adhesives to one or two layers therebetween. The peeling strength of the resulting product is improved, but is still relatively low. Further, as the gram weight of the film needs to be lower than 35 g/m², the problems stated above cannot be avoided.

CN 1229222C adopts a similar method, wherein a certain amount of adhesive is added to the formula of polyether-ester film and said film is directly laminated on a fabric material. With this method the cost of glue is lowered, but the function of film is damaged. Besides, the peeling strength of glue used in the later stage is not as good as those gel-type adhesives, resulting in problems like glue failure, curling, etc.

CN 1585844A only discloses heat setting of a polyether-ester fiber after dying, in order to maintain elasticity, flexibility and no curling. Nevertheless, it does not disclose application to its bonding products.

U.S. Pat. No. 6,187,696 B1 discloses bonding nonwoven with thermoplastic resin film using melt adhesive. It mainly explains the properties of the bonding products. U.S. Pat. No. 6,998,081 only discloses surface heating PP fiber bands or pipes in the drying tunnel after they are molded, so as to address shrinking problems caused by moisture and heat.

DE 19919357 discloses heat setting of PET resin film, and also discloses an apparatus consisting of drying oven and guide roller, aiming to solve crystallization and shrinking of film.

U.S. Pat. No. 5,376,430 discloses bonding polyolefin film with pressure-sensitive adhesive and bonding elastic films like polyurethane. It discloses back gluing pressure-sensitive adhesive on the surface of polyolefin film, and then bonding. It does not mention or disclose solutions for surface crimpling, curling, or glue failure. U.S. Pat. No. 5,445,874 only relates to bonding with polyurethane adhesive.

The prior art mainly focuses on modification of thermoplastic resin formula, mainly for the purposes to improve heat setting and heat shrinking rate of thermoplastic resin film or product.

Those problems commonly seen in bonding nonwoven with various thermoplastic resin films, e.g., a crimple appearance, curling inside the film, insufficient glue fastness, and glue failure, are still big troubles in the industry and causes of high defect rate. For laminates generally used as disposable products, increasing the amount of glue or changing the type of glue brings pressure to costs and greatly lowers maintenance of the film's functions, e.g., moisture transmission. Woven fabric products, when bonded with thermoplastic resin films, e.g., polyurethane film or polyether-ester film, may easily cause curling inside the film, stiff handfeel or other problems, making later stage cutting inconvenient and comfort descend. As such, it increases the bonding costs and gives huge pressure on achieving a stable technology and precise controlling of tensile force, hindering development of the market. Thermoplastic resin film has similar problems when bonding with other materials using pressure-sensitive adhesives, and thus has a stringent requirement on the type of pressure-sensitive adhesive to be used, greatly elevating technical requirements and limiting application of thermoplastic resin films. In view of the above, the solution of such problems has become strong demand of various industries.

### CONTENTS OF THE INVENTION

The present invention aims to provide a thermoplastic resin film laminate with smooth and non-crimpled appearance, no curling, soft handfeel, enhanced glue fastness, and no glue failure problems. It also provides a method for preparing the same.

On the one hand, to achieve the above purpose of the invention, this invention provides a thermoplastic resin film laminate formed by thermal compressing, wherein the laminate comprises:
at least a thermoplastic resin film layer with a thickness of 1-250 μm, which thermoplastic resin film layer can be molded by solution coating or bladecoating, or melt extrusion;
at least a thermoplastic resin product layer;
and a bonding layer of glue in between said thermoplastic resin film layer and said thermoplastic resin product layer.

In the laminate of the present invention, the thermoplastic resin product layer can be a thermoplastic resin film or thermoplastic resin fabric, while said thermoplastic resin fabric can be a woven fabric and/or a nonwoven.

In the laminate of the present invention, when the thermoplastic resin product layer is a fabric, it has a gram weight of 1-250 g/m², preferably 1-100 g/m², more preferably 5-60 g/m². The gram weight of the bonding layer is more than 0.1 g/m², preferably 0.8 g/m²-15 g/m², more preferably 0.8 g/m²-10 g/m².

In the laminate of the present invention, the thermoplastic resin film has a thickness of 1-250 μm, preferably 1-100 μm, more preferably 2-50 μm.

In the laminate of the present invention, when the thermoplastic resin product layer is also a thermoplastic resin film, identically, the thermoplastic resin film has a thickness of 1-250 μm, preferably 1-100 μm, more preferably 2-50 μm.

In the laminate of the present invention, the thermoplastic resin film material can be any thermoplastic plastics and its derivatives and mixtures, preferably polyolefin and its derivatives and mixtures, polyvinyl acetate and its derivatives and mixtures, PVC and its derivatives and mixtures, polyvinyl alcohol and its derivatives and mixtures, polyethylene terephthalate and its derivatives and mixtures, and polybutylene terephthalate and its derivatives and mixtures. The thermoplastic resin film material can be any thermoplastic elastomer and its derivatives and mixtures, preferably polyether-ester and its derivatives and mixtures, polyether-ester amide and its derivatives and mixtures, polyurethane and its derivatives and mixtures, TPO (thermoplastic polyolefin elastomer) and its derivatives and mixtures, as well as TPV (thermoplastic vulcanized rubber) and its derivatives and mixtures thereof.

In the laminate of the present invention, the fabric can be a woven fabric or nonwoven, wherein the woven fabric can be any fabric material, preferably polyether-ester and its derivative fibers, polyester and its derivative fibers, nylon and its derivative fibers, polyurethane and its derivative fibers, and polypropylene and its derivative fibers; nonwoven can be any nonwoven, preferably nonwoven of polyolefin and its derivative nonwoven, nonwoven of polyester and its derivative nonwoven, nonwoven of nylon and its derivative nonwoven, nonwoven of spunlace and its derivative nonwoven, nonwoven of degradable plant fiber and its derivative nonwoven, more preferably polypropylene nonwoven, polyester nonwoven, nonwoven of degradable plant fiber and its derivative nonwoven, etc.

In the laminate of the present invention, the glue used can be any glue, preferably solvent adhesive, water-based adhesive, hot melt adhesive, and solventless adhesive. The solvent adhesive includes reactive and unreactive adhesive, preferably moisture-reactive polyurethane glue, bi-component polyurethane glue, siloxane pressure-sensitive adhesive, rubber pressure-sensitive adhesive, polyester pressure-sensitive adhesive, polyester solvent adhesive, rubber solvent adhesive; water-based adhesive is preferably water-based acrylic acid glue, polyurethane glue, olefin hot melt adhesive, polyurethane hot melt adhesive, thermoplastic elastomer glue, rubber, polyester, pressure sensitive adhesive, etc.; hot melt adhesive is preferably polyurethane reactive glue, polyester, amide, olefin like SBS, SIS, SEBS, acrylic acids pressure sensitive adhesive, etc.

Preferably, in the laminate of the present invention, the bonding layer is a non-continuous layer to enhance laminate's performances of air and moisture transmission. More preferably, the bonding layer is non-continuous dot layer, or strip layer with bars or grid layer.

The laminate of the present invention may be a laminate comprising a thermoplastic resin film layer, a thermoplastic resin product layer and a bonding layer; or a laminate wherein the thermoplastic resin film lies between two layers of thermoplastic resin products layers and the layers are bonded with bonding layers respectively; or a laminate of more layers. For laminates with multiple layers, the materials used for bonding can be textile fabrics or nonwoven, or a mixture thereof.

The laminate of the present invention, no matter how many layers are bonded therein, after-treatment is required after bonding the thermoplastic resin films. Said after-treatment can be various after-treatment methods, preferably a thermal after-treatment method, especially a thermal compressing after-treatment.

On the other hand, to achieve the purpose of the invention, the present invention also provides a method for preparing the above-said thermoplastic resin film laminate, which comprises the following steps:
providing thermoplastic resin film layer with a thickness of 1-250 μm;
coating the thermoplastic resin film layer with glue;
applying thermoplastic resin product layer on the thermoplastic resin film layer coated with glue;
thermal after-treatment.

Preferably, in the method of the present invention, the thermoplastic resin film layer used in step (1) is a thermoplastic nonporous air transmission film. Tested with ASTM E96-2000 BW, the moisture transmission rate is more than 100 g/m²*24 h, preferably 1000 g/m²*24 h, more preferably over 5000 g/m²*24 h, and even more preferably over 7000 g/m²*24 h.

By weight percentage, the components of the film comprise:
10%-99% polyether-ester thermoplastic elastomer resin;
0.01%-90% inorganic powder material having a grain diameter no more than 100 μm and/or an organic low molecular material having a molecular weight no more than 20000 Daltons; and
0-5% dispersant, which is an organic material containing groups affinitive with polyether-ester thermoplastic elastomers.

The above film-making raw materials can be blended in machines with a double screw or a single screw, granulated after pre-blend melting or directly extruded to form films. Optimization is made according to different formulas. For instance, if it is organic low molecular formula, direct extrusion to form films is preferred. For the formula containing inorganic powders, however, it is preferable to pre-blend melting granulate and then to form the film. Film forming by extrusion may adopt multi-layer co-extrusion or single layer extrusion device, wherein the materials of each layer are the same for multi-layer co-extrusion. Preferably, there is single screw multi-layer co-extrusion or single-layer extrusion, more preferably there is one to three-layer extrusion. After that, the non-porous air transmission film is treated with intermediate special working processes such as surface treatment, solvent cleaning, printing, online ripening, and paint coating or adhesive coating, preferably with surface treatment, printing, sizing, and online ripening.

Preferably, in the method of the present invention, the glue coated in step (2) is non-continuous. The coating device can be any gel coating device, preferably roller coating device, spray coating device, slit coating device, and powdering device, etc., more preferably roller coating and spray coating device.

In the method of the present invention, the thermal after-treatment of step (4) can be online thermal treatment or off-line thermal treatment.

There are three critical technological parameters in the above-said thermal after-treatment, namely temperature, pressure and time. The temperature of thermal after-treatment can be 10-100° C. lower than the melting point of thermoplastic resin film or fiber product, taking the lower melting point of the two as final, preferably 12-90° C., more preferably 15-80° C. The pressure of thermal after-treatment can be 0.01-1 MPa, preferably 0.01-0.6 MPa. The time for thermal treatment can be 0.001 s-3600 s. The three factors, temperature, pressure and time, are keys whether the products can be successfully prepared.

The thermal after-treatment device of the present invention can be various thermal after-treatment devices, preferably various roller machines (two-roller or multi-roller), big drying oven, board press machine, thermal guide roller, thermal rolling mill, etc.

The bonding products of the present invention have a smooth, non-crimple appearance, no curling, soft handfeel, and an enhanced glue fastness, the testing standard being JIS L 1096. As to handfeel, the elastomer module therein is tested under ASTM D828, and the softness can be tested under ISO 17235-2002. The thinner products take ASTM D828 standard, wherein a smaller value indicates a softer handfeel; the thicker products fit ISO 17235-2002, wherein a greater value indicates a softer handfeel. The above performances can all be closely connected to the technological parameters of thermal after-treatment.

Hereinbelow the present invention is further illustrated in combination with the drawings and embodiments. These embodiments, however, are only explanations of some specific embodiments of the present invention, and shall not be construed as limitation of the present invention.

### DESCRIPTION OF THE DRAWINGS

FIG. 1 is a flowchart for preparing thermoplastic resin film laminate according to an embodiment of the present invention;

FIG. 2 is a flowchart for preparing thermoplastic resin film laminate according to another embodiment of the present invention;

FIG. 3 demonstrates the preparation technology of the present invention.

### EMBODIMENTS

In the embodiments below, the gram weight, peeling strength, evenness, and moisture transmission rate are tested as follows:

### (1) Testing Standard of Gram Weight:

Testing device: analytical balance, precision 0.001 g;

Sampling standard: starting at 15 mm away from the widthwise edge, sampling every 60 mm widthwise, and sampling every 300 mm lengthwise; the testing sample size is 100×100 mm, and the number of samples taken from the widthwise and lengthwise is 100 pieces in total;

### (2) Testing Standard of Peeling Strength:

Testing standard: GB8808-1988;

Sampling standard: starting at 15 mm away from the widthwise edge, sampling every 150 mm widthwise, and sampling every 500 mm lengthwise; the testing sample size is 15×180 mm, and the number of samples taken from the widthwise and lengthwise is 100 pieces in total;

### (3) Evenness Standard:

Even appearance, no crease/curling/scratch/pores in the recombined inner film and outer side double-layer nonwoven. Crease and curling are visible by naked eyes. Scratches are visible by naked eyes, and also by watching permeation of liquid when liquid is coated under certain pressure.

### Moisture Transmission Rate:

In accordance with the ASTM E96 steamed water transmission Method, air speed being 1 m/s, moisture rate being 50%, temperature being 23° C., the moisture device being produced by Eastern Asia Precision Machine Corporation.

### Example 1

A 12 μm polyurethane thermoplastic resin film and a 190 g/m² gram weight polyester two-way spandex knitted fabric are dotted micro gravure bonded with reactive type hot melt polyurethane adhesive. The glue has a gram weight of 6 g/m², the speed of the production line is 30 m/min. The bonded product is thermally after-treated on-line (by thermal pressure roller), the temperature being 100° C., pressure being 1.0 MPa, cooled, rolled up and matured with glue. The product obtained has a smooth surface, the material is not curled at film-side, the test result of softness ISO 17235-2002 is 3.4, the test result of peeling strength GB8808-1988 is 6.0 N/15 cm. The test result of softness of the bonding product that is not thermally after-treated on-line is 2.9, the average of the test results of the peeling strength GB8808-1988 is 4.5 N/15 cm, with a curling appearance.

### Example 2

A 5 μm polyether-ester thermoplastic resin film and a 40 g/m² polyolefin PP nonwoven are spray coating bonded with SIS type hot melt adhesive. The glue has a gram weight of 0.8 g/m², the speed of the production line is 100 m/min. The bonded product is thermally after-treated on-line (by thermal pressure roller), the temperature being 100° C., pressure being 1.0 MPa, cooled and rolled up. The product obtained has a smooth surface, the material is not curled at film-side, the test result of softness ISO 17235-2002 is 6.2, the test result of peeling strength JIS L1096 is 1.2 N/15 cm. The test result of softness of the bonding product that is not thermally after-treated on-line is 5.0, the average of the test results of the peeling strength GB8808-1988 is 0.9 N/15 cm.

### Example 3

The film surface of the bonded product prepared by Example 2 continues to be spray coating bonded with 20 g/m² polyolefin PP nonwoven are spray coating with SIS type hot melt adhesive. The glue has a gram weight of 1 g/m², the speed of the production line is 100 m/min. The bonded product is thermally after-treated on-line (by thermal pressure roller), the temperature being 100° C., pressure being 1.0 MPa, cooled and rolled up. The product obtained has a smooth surface, the nonwoven is not curled at film-side, the test result of softness ISO 17235-2002 is 5.2, the test result of peeling strength GB8808-1988 is 0.8 N/15 cm. The test result of softness of the bonding product that is not thermally after-treated on-line is 4.8, the average of the test results of the peeling strength GB8808-1988 is 0.6 N/15 cm.

### Example 4

The technological temperature of Example 2 is changed to 120° C. The product obtained also has a smooth surface, the nonwoven is not curled at film-side, and there is no glue failure. The test result of softness ISO 17235-2002 is 6.8, the average test result of peeling strength GB8808-1988 is 1.8 N/15 cm. Compared with the test results of Example 2, the temperature elevation enhances the product's softness and peeling strength.

### Example 5

The technological temperature of Example 2 is changed to 140° C. The product obtained also has a smooth surface, the nonwoven is not curled at film-side, and there is no glue failure. The test result of softness ISO 17235-2002 is 5.0, the average test result of peeling strength GB8808-1988 is 0.8 N/15 cm. Compared with the test results of Example 2, when the temperature is elevated closer to the melting point of polypropylene nonwoven, the product resulted will be more rigid and the peeling strength will be weakened.

### Example 6

The technological pressure of Example 2 is changed to 0.6 MPa. The product obtained also has a smooth surface, the nonwoven is not curled at film-side, and there is no glue failure. The test result of softness ISO 17235-2002 is 6.2, the average test result of peeling strength GB8808-1988 is 1.0 N/15 cm. Compared with the test results of Example 2, the pressure decrease will result in weakening of the peeling strength.

### Example 7

The production speed of Example 2 is changed to 50 m/min. The product obtained also has a smooth surface, the nonwoven is not curled at film-side, and there is no glue failure. The test result of softness ISO 17235-2002 is 6.2, the average test result of peeling strength GB8808-1988 is 1.5 N/15 cm. Compared with the test results of Example 2, the peeling strength is slightly improved.

### Example 8

The thermoplastic resin film and nonwoven of Example 2 are bonded and directly rolled up according to the flowchart of FIG. 2. It is rested for 1 h, 24 h, 48 h, and 30 days, and then after-treated. Similarly, the product obtained has a smooth surface, the nonwoven is not curled at film-side, and there is no glue failure. The softness and peeling strength is similar to or the same as those of Example 2.

### Example 9

The thermoplastic resin film and nonwoven of Example 1 are bonded and directly rolled up according to the flowchart of FIG. 2. It is matured with glue in the maturing room, and rolled up for thermal after-treatment (after-treatment in oven), the temperature being 100° C., and the pressure inside the oven is 1 MPa. Thirty minutes later test results are obtained which are similar to those of Example 1.

### Example 10

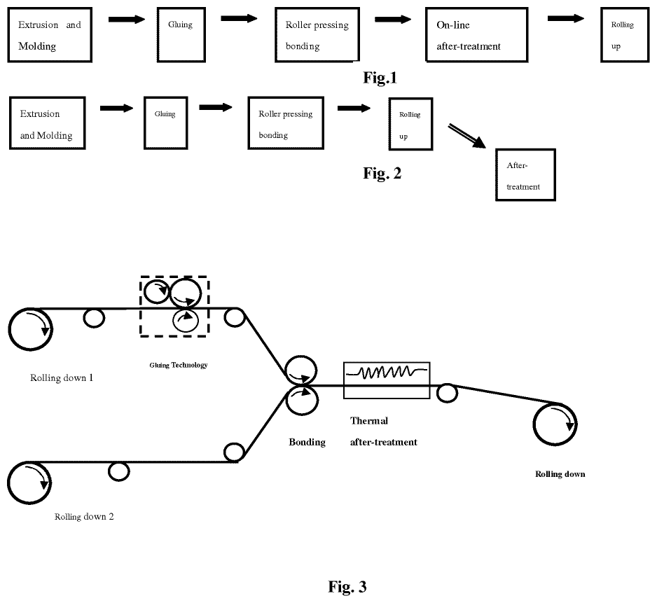

A 15 μm polyethylene thermoplastic resin transparent film and a 20 μm PET thermoplastic resin transparent film are roller coating bonded with solvent-type polyurethane glue according to the flowchart of FIG. 1, the glue having a gram weight of 2 g/m². After bonding, it is directly after-treated on line, the temperature being 80° C., the pressure being 0.1 MPa, and the speed being 60 m/min, resulting a bonding product of which the PET film is not curled toward the polyethylene film, and which has a smooth surface. The test result of peeling strength GB8808-1988 is 21.5 N/15 cm. The average test results of peeling strength of the product that is not thermally after-treated is 15 N/15 cm.

### Example 11

A 15 μm polyethylene thermoplastic resin matte film and a 5 μm polyether-ester thermoplastic resin matte film are roller coating bonded with water-based acrylic acid pressure-sensitive adhesive according to the flowchart of FIG. 1, the glue having a gram weight of 1 g/m². After bonding, it is directly after-treated on line (by thermal pressure roller), the temperature being 90° C., the pressure being 0.1 MPa, and the speed being 80 m/min, resulting a product having a smooth surface, no curling, and no glue failure with long-term tension free stay. The test result of peeling strength GB8808-1988 average 0.5 N/15 cm. The test results of peeling strength of the product that is not thermally after-treated average 0.1 N/15 cm. The test result of elasticity modulus ASTM D828 is 75 MPa/80 MPa, and the test result of the one that is not thermally after-treated is 100 MPa/120 MPa.

### Example 12

The on-line thermal after-treatment of Example 1 is changed to a board press device, and similar results are obtained.

### Example 13

A 5 μm polyether-ester thermoplastic resin film and a 23 g/m² polypropylene spunbond (PP spunbond) are Gravure roller coated with water-based acrylic acid hydrosol, and bonded after drying, the glue having a gram weight of 1.3 g/m², the speed of the production line being 100 m/min. The bonded product is thermally after-treated on-line (by thermal pressure roller), the temperature being 120° C., pressure being 0.6 MPa, cooled and rolled up. The product obtained has a smooth surface, and the nonwoven is not curled at film-side. The test result of softness ISO 17235-2002 is 4.8, the test results of peeling strength GB8808-1988 average 0.7 N/15 cm, and the moisture-transmission rate is 1036 g/m²*24 h. The test result of softness of the bonding product that is not thermally after-treated on-line is 4.1, and the test results of peeling strength GB8808-1988 average 0.3 N/15 cm, with a curling appearance and a moisture transmission rate of 1012 g/m²*24 h.

### Example 14

A 5 μm polyether-ester thermoplastic resin film and a 23 g/m² polypropylene spunbond (PP spunbond) are Gravure roller coated with water-based acrylic acid hydrosol, and bonded after drying, the glue having a gram weight of 1.3 g/m², the speed of the production line being 100 m/min. Placed in well ventilated ordinary environment for 1 min or more, the bonded product is again rolled down to be thermally treated with a thermal pressure roller (by thermal pressure roller), the temperature being 120°, pressure being 0.6 MPa, cooled and rolled up. The product obtained has a smooth surface, and the nonwoven is not curled at film-side. The test result of softness ISO 17235-2002 is 4.8, the test results of peeling strength GB8808-1988 average 0.7 N/15 cm. The performance of the bonding product that is not thermally after-treated on-line is the same as that of Example 13.

### Examples 15 and 16

The bonding products of Examples 13 and 14 are re-bonded with 23 g/m² polypropylene spunbond (PP spunbond), the re-bonding technologies are respectively the same as those in Examples 13 and 14. The resulting product has a smooth surface and no curling. The test result of softness ISO 17235-2002 is 4.10, the test results of peeling strength GB8808-1988 average 0.4 N/15 cm, and the moisture transmission rate is 1010 g/m²*24 h. The bonding product that is not thermally after-treated on-line has a test result of softness of 4.1, an average test result of peeling strength GB8808-1988 of 0.3 N/15 cm, a wrinkled appearance and a moisture transmission rate of 960 g/m²*24 h.

### Examples 17, 18, 19 and 20

The film of Examples 13 and 14 is changed to a polyether-ester thermoplastic resin film of 10 μm and 15 μm. Basic performances such as the peeling strength, softness and appearance of the resulting products are similar. After thermal treatment, the moisture transmission rate is dropped to 960 g/m²*24 h and 900 g/m²*24 h.

### Examples 21, 22 and 23

The nonwoven of Examples 13 and 14 is changed to 40 g/m² white maize degradable nonwoven, 30 g/m² yellow maize degradable nonwoven, 35 g/m² nylon reusable spunlacing nonwoven. The peeling strength is 1.1 N/cm, the softness is similar to nonwoven, the appearance is smooth. After thermal treatment, the moisture transmission rate is 1000 g/m²*24 h, and 1060 g/m²*24 h.

### Examples 24 and 25

The glue of Example 23 is changed to moisture-reactive type hot melt adhesive and butanone hot melt adhesive. After respective coating and the same treatment, the resulting product has a smooth appearance and no curling. The softness has increased by 0.3, the test result of peeling strength GB8808-1988 average 5.0 N/15 cm, there is a wrinkled appearance and the moisture transmission rate is 870 g/m²*24 h.

What is claimed is:

1. A method for preparing a thermoplastic resin film laminate, comprising:
(a) providing a thermoplastic resin film layer with a thickness of 1-250 μm and having a first melting point;
(b) providing a thermoplastic resin product layer has a second melting point;
(c) applying a bonding layer of glue onto either the thermoplastic resin film layer or the thermoplastic resin product layer;
(c) roller press bonding the thermoplastic resin film layer and the thermoplastic resin product layer together to form an intermediate product; and
(d) subjecting the intermediate product to a thermal after-treatment,
wherein the thermal after-treatment is conducted at (i) a temperature of 10° C.-100° C. lower than lower of the first melting point and the second melting point, (ii) at a pressure of 0.01-1 MPa, and (iii) the thermal after-treatment time ranges from 0.001 s-3600 s, and wherein the thermal after-treatment is conducted with a thermal after-treatment device selected from a drying oven or a board press machine.

2. The method of claim 1, wherein the thermoplastic resin film is a thermoplastic plastics and its derivatives and mixtures selected from: polyolefin and its derivatives, polyvinyl acetate and its derivatives and mixtures, PVC and its derivatives and mixtures, polyvinyl alcohol and its derivatives and mixtures, polyethylene terephthalate and its derivatives and mixtures, and polybutylene terephthalate and its derivatives and mixtures.

3. The method of claim 1, wherein one or more layers of the thermoplastic resin film are selected from any one or more groups of the following thermoplastic elastomers and their derivatives and mixtures: polyether-ester and its derivatives and mixtures, polyether ester amide and its derivatives and mixtures, polyurethane and its derivatives and mixtures, TPO and its derivatives and mixtures, as well as TPV and its derivatives and mixtures thereof, and any mixtures of the aforesaid materials.

4. The method of claim 1, wherein one or more layers of the thermoplastic resin product layer comprises a fabric.

5. The method of claim 3, wherein the fabric comprises a nonwoven fabric.

6. The method claim 1, wherein the glue is a solvent adhesive, a water-based adhesive or a solventless adhesive.

7. The method of claim 1, wherein the bonding layer has a basis weight of 0.8 g/m²-50 g/m².

8. The method of claim 1, wherein the bonding layer is a non-continuous layer having a non-continuous dot layer, strip layer, or grid layer.
